(19) United States
(12) Patent Application Publication
(10) Pub. No.: US 2025/0364863 A1
(43) Pub. Date: Nov. 27, 2025

(54) ALUMINUM ELECTRIC MOTOR HOUSING WITH INTEGRAL PASSIVE COOLING VAPOR CHAMBERS AND PROCESS FOR FORMING UTILIZING 3D PRINTING TECHNIQUES

(71) Applicant: Martinrea International US Inc., Auburn Hills, MI (US)

(72) Inventor: Steven W. Geddes, Ann Arbor, MI (US)

(21) Appl. No.: 19/212,997

(22) Filed: May 20, 2025

Related U.S. Application Data
(60) Provisional application No. 63/650,581, filed on May 22, 2024.

(51) Int. Cl. H02K 5/20; B22F 10/28; B22F 10/73; B22F 12/63; B22F 12/67; B33Y 10/00; B33Y 80/00; H02K 9/193; H02K 9/22; H02K 15/14

(52) U.S. Cl. CPC H02K 5/20; B22F 10/28; B22F 10/73; B22F 12/63; B22F 12/67; B33Y 10/00; B33Y 80/00; H02K 9/193; H02K 9/225; H02K 15/14; B22F 2301/052

(57) ABSTRACT

An electric motor housing fabricated from an aluminum alloy, such as via an additive printing process. The motor housing can integrate vapor chambers which in use are charged with a working fluid in an evaporation (vapor)-condensation (liquid) cycle for providing transfer of heat from a location of high heat to an area of lower heat for the purpose of heat dissipation. The number and size of the vapor chambers are determined to match the expected heat transfer need, taking into consideration typical motor loads, peak motor loads, and optional supplemental methods of removing heat. The vapor chambers can be supplemented by cooling paths according to any shape or configuration for further assisting in moving heat away from the heat source.

### CROSS REFERENCE TO RELATED APPLICATIONS

The present application claims priority of U.S. Ser. No. 63/650,581 filed May 22, 2024.

### FIELD OF THE INVENTION

The present invention relates generally to an electric motor housing. More specifically, the present invention teaches an electric motor housing, such as for use in an electric or EV vehicle, fabricated from an aluminum alloy via an additive or 3D printing process, further including, without limitation, a laser powder bed fusion (LPBF) process. The printed motor housing can integrate heat pipes (hereinafter referenced as two-phase passive cooling vapor chambers) as part of the 3D or additive forming process for creating the housing, and for the purpose of conducting/convecting heat away from the stator windings of an electric motor, and without having to separately insert stand alone heat pipes. Alternatively, the invention can integrate active liquid cooling paths which are organic in form mimicking structures seen in nature, and which can supplement the passive heat pipes/vapor chambers where passive thermal management alone is not sufficient to maintain a desired temperature. Alternatively, bio-mimicking cooling paths which are organic in form, mimicking structures seen in nature can be utilized, such as in combination with two-phase heat pipe/vapor chamber cooling options.

### BACKGROUND OF THE INVENTION

Electric motors are used in a wide range of applications including fans, pumps, power tools and, increasingly, in transportation, in particular with electric and hybrid vehicles. Regardless of the use, maintaining the operating temperature is critical to increase the useful life of a motor. Excessive heat, among other factors, contributes to the degradation of critical components which, when it fails, renders the motor inoperable. Thus, electric motors have a range of temperature which is preferred in order to provide for long life of the motor. Furthermore, operating in an optimal range improves the efficiency of motor. As is further known, motor windings (typically constructed from copper) exhibit a property whereby electrical resistance increases with temperature (also termed as a positive temperature coefficient of resistance).

Given the areas of high heat generation (such as again proximate the electric motor windings) a further issue is the maldistribution of such generated heat within the motor and the desire to transfer/redistribute the heat in an order to reduce the maximum temperature of the motor and surrounding housing.

In traditional vehicles with internal combustion engines, heat is removed from the engine via a liquid cooling circuit which then releases the heat to ambient via a heat exchanger (i.e. radiator). Electric vehicles (EVs) typically use the same strategy, namely that a coolant is circulated in close contact with a motor to remove heat to a radiator.

Electric Vehicles are seeing rapid adoption in many parts of the world as government mandates and incentives have been put in place to phase out or limit the sale of traditional vehicles propelled by internal combustion (ICE) engines. Automakers are responding with a growing range of EVs across a wide range of vehicle segments. With that comes engineering challenges as the principal propulsion system for the past hundred plus years is phased out in favor of a completely new propulsion system.

As is further known, EVs are propelled by at least one electric motor connected to the drive wheels. In some models, multiple motors are used to drive different sets of wheels or even individual “hub motors” in each wheel itself. Each motor is a concentrated source of heat from magnetic field switching, electrical conductance (through the windings), and friction. The heat can ultimately lead to bearing and/or winding insulation failures leading to a breakdown of the motor. Moreover, electrical motors have a preferred operating temperature range to maintain peak efficiency (low energy losses) in addition to extending the operating life.

Electric motors are typically cooled via a liquid cooling loop. A pump and conduit system flows a liquid coolant in close contact with the motor whereby the motor heat is transferred to the liquid. The hot liquid then flows away from the motor where the heat can be dissipated either into the atmosphere (via a radiator) or directed for a heating use within the vehicle (e.g., to heat the passenger cabin to a desired temperature or to heat the battery cells to help maintain their optimal temperature). The system is not so different than what has been commonly used for ICE propulsion systems for many decades. Such a system requires control over the fluid flow (sensors and actuators as part of a thermal management system), external components such as a pump and radiator, fluid passages and connections, and a certain volume of coolant liquid.

As is also known, loads are limited by a motor's thermal limit condition, especially the maximum temperature allowed inside the motor, where the windings and permanent magnets reside. If the temperature is not controlled, materials can exceed their normal operating temperatures and experience phase change, softening, melting, or other forms of degradation. Thermal stresses that can cause fatigue, cracking, and material deformation which shorten a motor's lifetime and can also lead to serious safety issues. For example, some electric motors use rare earth magnets that can overheat to the point that they become demagnetized. Thus, maintaining optimal temperature levels is necessary for the sake of avoiding efficiency reduction and ensuring a more reliable and robust motor. To that end, the generated heat must be managed by an appropriate cooling system.

### SUMMARY OF THE INVENTION

The present invention teaches an electric motor housing, such as fabricated from an aluminum alloy via a 3D printing process and including, without limitation, laser powder bed fusion (LPBF). In a first variant, the motor housing can integrate any passive two-phase cooling vapor chambers (generally again referenced as heat pipes) for providing for the transfer of heat from a location of high heat to an area of lower heat for the purpose of heat dissipation. The number and size of the vapor chambers is determined to match the expected heat transfer requirements, such as at the motor winding locations which are determined to be the area of highest heat generation, taking into consideration typical motor loads, peak motor loads, optional supplemental methods of removing heat, and engineering safety factors.

In a further embodiment, the passive cooling provided by the vapor chambers is supplemented with liquid cooling paths or channels. The ability to 3D print the housing avoids any restrictions in the design of the cooling paths.

In the simplest form, the vapor chambers transfer heat to the condensation end of the chamber which is dissipated to ambient air without the need for any additional directed air flow or any coolant flow. Optionally, air convection can be directed to the evaporator end of the chamber to increase the rate of heat transfer and which can be achieved by scoops, ducts or conduits which redirect the air flow around and/or under a vehicle as it moves so that a certain amount is redirected toward the motor.

Alternatively, a fan can be incorporated to direct air toward the condenser end of each vapor chamber. In either the air-redirection or the fan-forced-convection case, cooling fins can be incorporated at the condenser end of each vapor chamber to provide additional surface area facilitating heat transfer from the vapor chamber to the surrounding air.

The heat pipes are charged with a working fluid which passively cycles in an evaporation (vapor)-condensation (liquid) cycle to move heat away from the heat source. The working fluid, such as but not limited to acetone, is chosen for its heat-carrying capacity as well as compatibility with aluminum to avoid degradation, corrosion or chemical reaction.

In a further embodiment, the passive cooling provided by the integrated vapor chambers is supplemented with liquid cooling paths or channels which can be formed parallel or which are organic and bio-mimicking structures as seen in nature. The ability to 3D print the housing avoids any restrictions in the design of the cooling paths. The working fluid, such as but not limited to acetone, is chosen for its heat-carrying capacity as well as compatibility with aluminum to avoid degradation, corrosion or chemical reaction.

The choice of cooling channel paths are limited only by the additive or 3D printing process employed, with the channels in one non-limiting arrangement being arranged in any of parallel, spiral, organic bio-mimicking, etc. fashion. The ability to 3D print the housing according to a given configuration is further only meaningfully limited by the ability to remove unfused powder from the printing process.

Coolant flowing in close contact with the motor will transfer heat for dissipation away from the motor, typically via a radiator. The bio-mimicking cooling paths can be engineered via optimization algorithms, such that fluid flow is directed to the areas of highest heat within the motor. Furthermore, bio-mimicking cooling channels, by their organic form mimicking what is found in plants and nature, improves the energy efficiency of a thermal system by reducing the fluid flow pressure drop as it is pumped through the system.

### BRIEF DESCRIPTION OF THE DRAWINGS

Reference will now be made to the attached drawings, when read in combination with the following detailed description, wherein like reference numerals refer to like parts throughout the several views, and in which:

FIGS. 1A-1D presents a series of views depicting electric motor cooling strategies according to the Prior Art and including each of (a) surface air cooling with a fan coupled to the shaft, (b) liquid cooling with a coolant jacket (c) heat pipe cooling with attached fins and a centrifugal fan, and (d) hybrid cooling with heat pipes and liquid;

FIG. 2 presents a perspective view of a liquid cooled electric motor according to the Prior Art such as which can be produced according to a non-limiting embodiment and depicting bio-mimicking cooling.

FIG. 2A presents a cutaway view along line 2A-2A of FIG. 2 and further depicts a three dimensional section of a liquid cooling channel system incorporated into a representative electric motor housing according to the existing art;

FIG. 3 presents a further rotated opened view of a liquid cooled electric motor such as according to the Prior Art however which can be produced according to the additive printing process of the present invention;

FIGS. 4A-4B provide a side-by-side comparison of vapor chamber versus heat pipe assemblies and illustrating the ability of the vapor chamber to spread heat, whereas the heat pipe moves heat;

FIG. 5 provides a cutaway illustration along line 5-5 of FIG. 4B and depicting the operation a heat pipe;

FIG. 6A provides a cutaway illustration along line 6A-6A of FIG. 4A and depicting the operation of a vapor chamber;

FIG. 6B presents a partially phantom perspective of the vapor chamber of FIG. 6A and illustration the spreading distribution of heat

FIG. 7 provides a perspective illustration of a housing produced according to a non-limited embodiment of the present invention and depicting a circumferential extending arrangement of vapor chambers in combination with embedded parallel flow liquid cooling channels having both and inlet end and an outlet end (hidden from view);

FIG. 8A provides a cross section of an e-motor/stator housing showing liquid coolant from an inlet manifold to an outlet manifold;

FIG. 8B provides an enlarged outer wall section of the e-motor/stator housing in FIG. 8A and showing the two-phase vapor chamber (heat spreader) and embedded cooling channels (single phase cooling);

FIG. 9 presents an illustration of an e-motor/stator cylindrical shaped housing exhibiting coolant flow between inlet and outlet locations with a manifold that extends the length of the housing, in combination with communicating and parallel flow coolant channels which extend about the circumference of the housing;

FIG. 10 presents an illustration of an e-motor housing according to a non-limiting embodiment and including a plurality of nine separate vapor chambers, each spanning forty degrees of the circumference and length of the e-motor housing;

FIG. 11A presents an enlarged cross section of an e-motor/stator housing similar to FIG. 8B and depicting heat transfer from the motor winding through the vapor chamber to the liquid coolant flowing through the coolant channels;

FIG. 11B presents an enlargement of area 11B depicted in FIG. 11A and better showing the two-phase evaporation and condensation cycle within the vapor chamber facilitated by the porous walls lining the vapor chamber;

FIG. 12 is a representative illustration of a laser powder bed fusion process for 3D forming an aluminum electric motor housing; and

FIG. 13 is a related illustration to FIG. 12 and depicting a roller configuration for recoating the aluminum powder between each laser fusion cycle.

### DETAILED DESCRIPTION OF THE PREFERRED EMBODIMENTS

The present invention discloses an electric motor housing fabricated from an aluminum alloy, such as via a 3D printing process including, without limitation, laser powder bed fusion (LPBF). As is known, loads are limited by a motor's thermal limit conditions, especially the maximum temperature allowed inside the motor, where the windings and permanent magnets reside. If the temperature is not controlled, materials can exceed their normal operating temperatures and experience phase change, softening, melting, or other forms of degradation. Thermal stresses that can cause fatigue, cracking, and material deformation which shorten a motor's lifetime and can also lead to serious safety issues. For example, some electric motors use rare earth magnets that can overheat to the point that they become demagnetized. Thus, maintaining optimal temperature levels is necessary for the sake of avoiding efficiency reduction and ensuring a more reliable and robust motor. To that end, the generated heat must be managed by an appropriate cooling system.

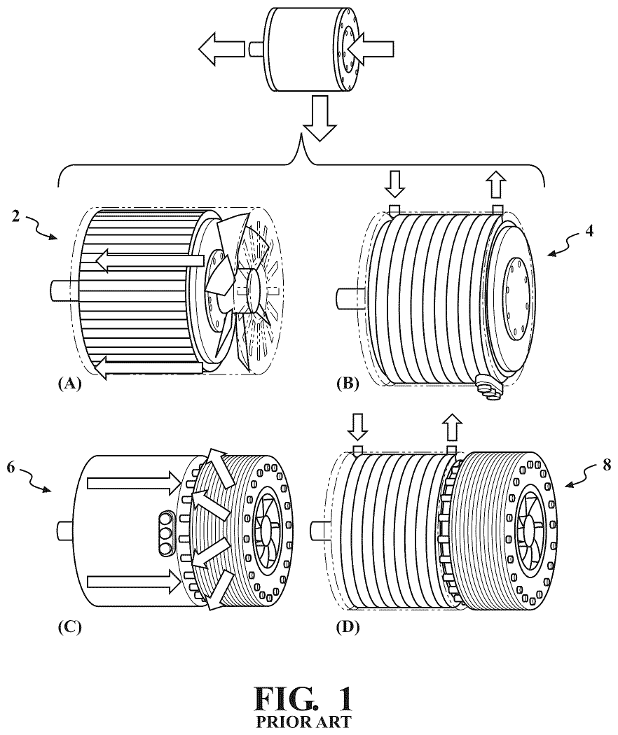

With reference initially to FIGS. 1A-1D, a series of views are shown respectively at each of 2, 4, 6 and 8 respectively depicting electric motor cooling strategies according to the Prior Art and including each of (a) surface air cooling with a fan coupled to the shaft, (b) liquid cooling with a coolant jacket (c) heat pipe cooling with attached fins and a centrifugal fan, and (d) hybrid cooling with heat pipes and liquid. Choosing an optimal cooling system depends on the intended application, motor mounting location, operating environment, among other factors.

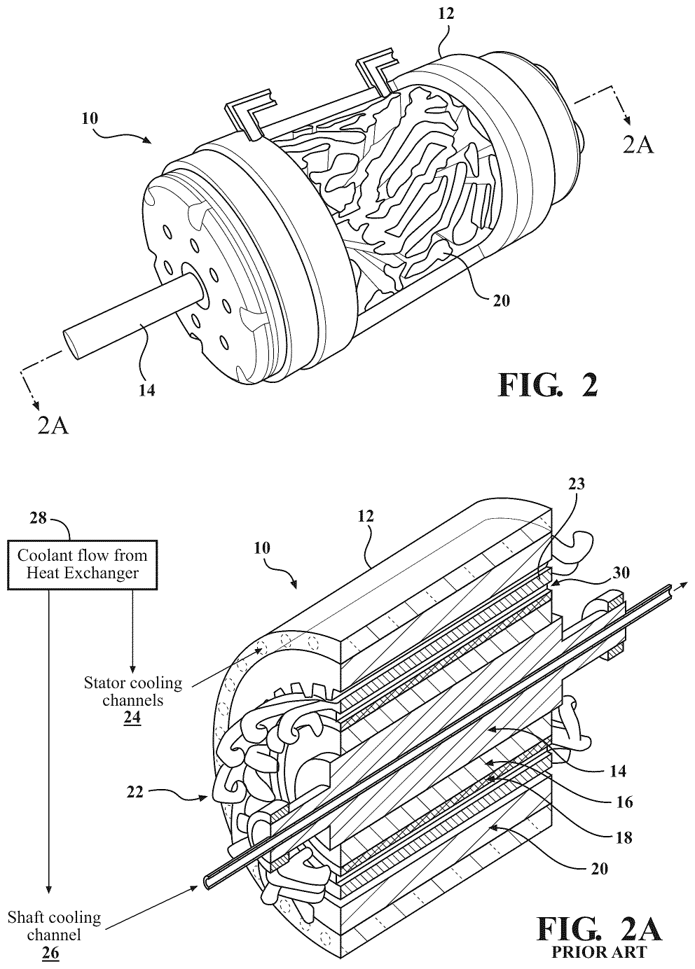

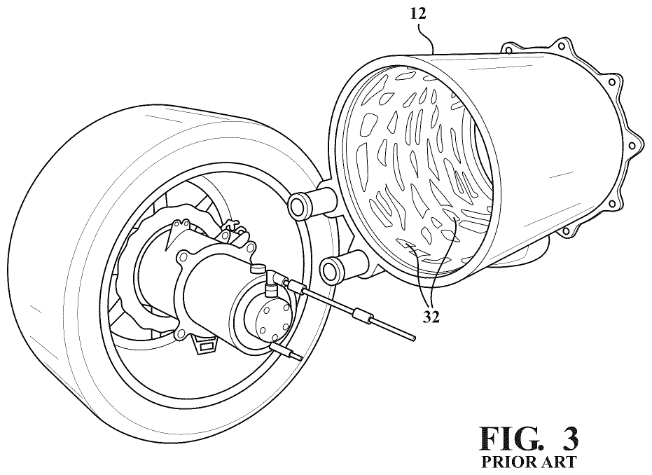

FIG. 2 presents a perspective view of a liquid cooled electric motor, generally at 10 having an outer body or housing 12 in partially phantom depiction according to one non-limiting embodiment of the invention for showing bio-mimicking cooling. As will be further described, the housing 12 can be produced according to a three-dimensional (3D) printing or additive process according to further aspects or embodiments the present invention.

As is also known, electric motors are mostly cooled by a liquid cooling system that consists of water cooling and oil cooling. Water is used in cooling jackets for indirect cooling, while oil enters the internal part of the motor to cool the hot spot directly. Liquid cooling can also be used to dissipate heat from an electric motor, with ethylene glycol or other liquid cooling agent circulated in or around the motor housing or coils to dissipate heat.

FIG. 2A presents a cutaway view along line 2A-2A of FIG. 2 and further depicts a three dimensional section better illustrating the construction of a representative e-motor assembly according to the existing art and depicting a liquid cooling channel system according to the prior art incorporated into the electric motor housing. The e-motor housing 12 surrounds each of an inner shaft 14, a rotor 16 with a plurality of laminations, a plurality of magnets 18, an outer-most stator laminations 20, along with a plurality of end-windings 22 which include an inner sleeve shape portion 23 disposed between the stator laminations and magnets.

In the representative illustrated embodiment of FIG. 2A, stator cooling channels 24 are depicted which are formed into the motor housing 12 and contain the suitable liquid which flows axially from the front to the rear of the motor. In contrast, the present invention teaches engineering, via optimization, cooling paths which are either parallel or organic in form so as to mimic structures seen in nature.

According to the representative prior art depiction of the e-motor assembly of FIG. 2A, a cooling channel 26 is formed in the rotor shaft 14 and exhibits a similar circular cross-section. As in the stator channel, the liquid flows axially along the motor's rotation axis from the front to the rear of the motor shaft 14. The coolant pipe from the heat exchanger, see as diagrammatically indicated at 28, is connected to the motor cooling channels at the inlet and outlet for thermal behavior evaluation. An air gap 30 is also depicted which separates the magnets 18 from the sleeve shaped portion 23 associated with the end windings 22.

FIG. 3 presents a further rotated opened view of a liquid cooled electric motor according to an existing configuration and which depicts a housing 12 separated from the fan and coolant supplying end assembly to depict an integrated arrangement of cooling pathways or channels 32, and such as which can further be produced according to the 3D printing process forming a portion of the present invention.

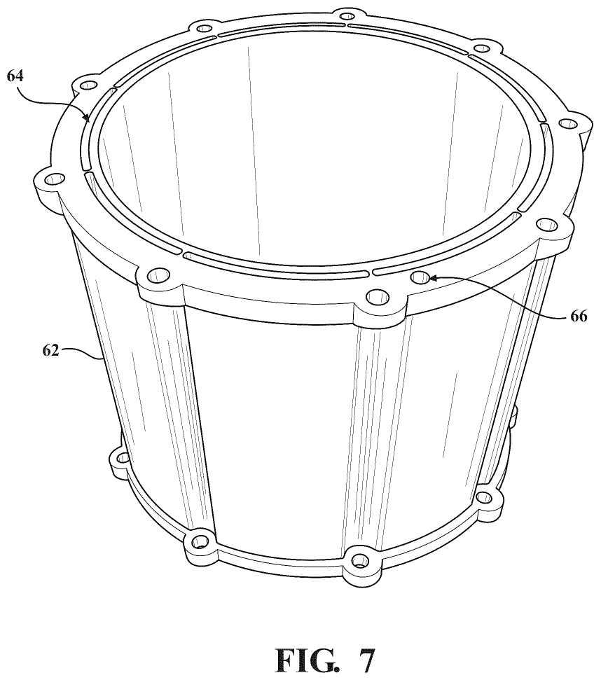

Without limitation, the motor housing of the present invention (such as again referenced in FIG. 7 et seq.) again describes engineering, again via optimization, of cooling paths which are organic in form and mimicking structures seen in nature which can be produced according to the desired three-dimensional printing process. As further shown, and in addition to parallel extending paths, the cooling paths 32 can be optionally provided in a spiraling pattern (see again as compared to prior art linear cooling channels depicted in FIG. 2A cutaway). Other non-limiting options include the cooling paths extending parallel out and back, as well as again being bio-mimicking in nature.

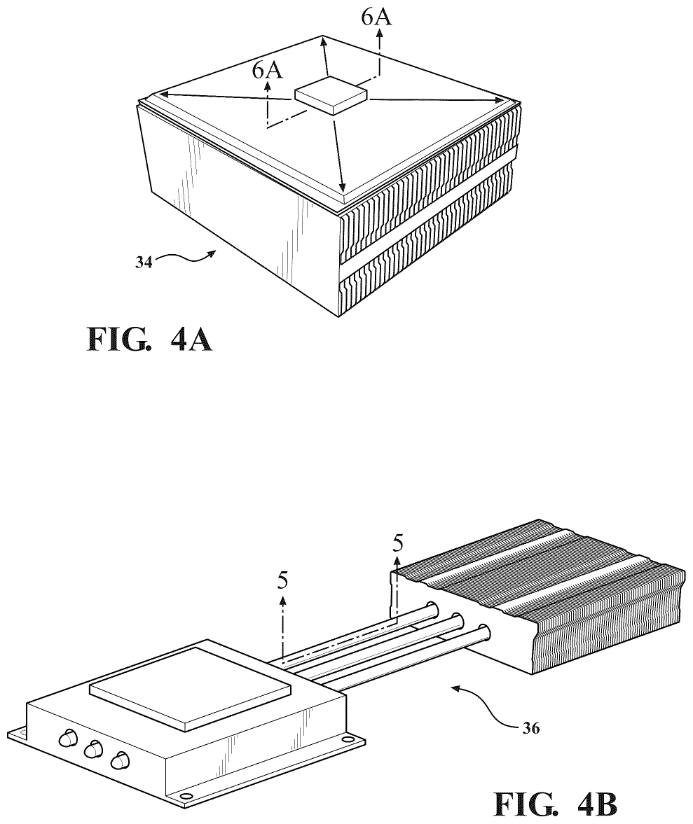

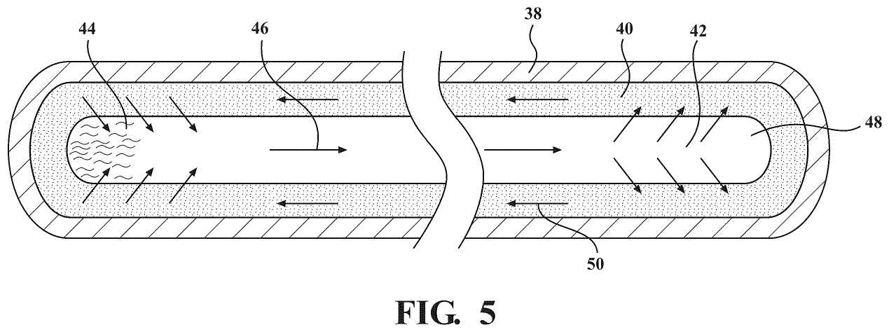

FIGS. 4A-4B provide a side-by-side comparison of a vapor chamber, generally shown at 34, versus a heat pipe assembly at 36, and illustrating the ability of the vapor chamber to spread heat, whereas the heat pipe moves heat. FIG. 5 provides a cutaway illustration along line 5-5 of FIG. 4B and depicting the operation a heat pipe which includes a casing 38 surrounding an interior wick 40 with an inner cavity 42.

In operation, a working fluid (not limited to any of an acetone, ammonia or refrigerant) within the wick 40 responds to being in proximity to an area of high heat (e.g. an e-motor winding) by evaporating at 44 to a vapor within the cavity 42. The vapor migrates, at 46, linearly along the cavity to a lower temperature end. At 48, the vapor condenses back to a fluid and is absorbed by the wick 40, thereby releasing thermal energy. Finally, at step 50, the working fluid flows back to the higher temperature end and the cycle repeats.

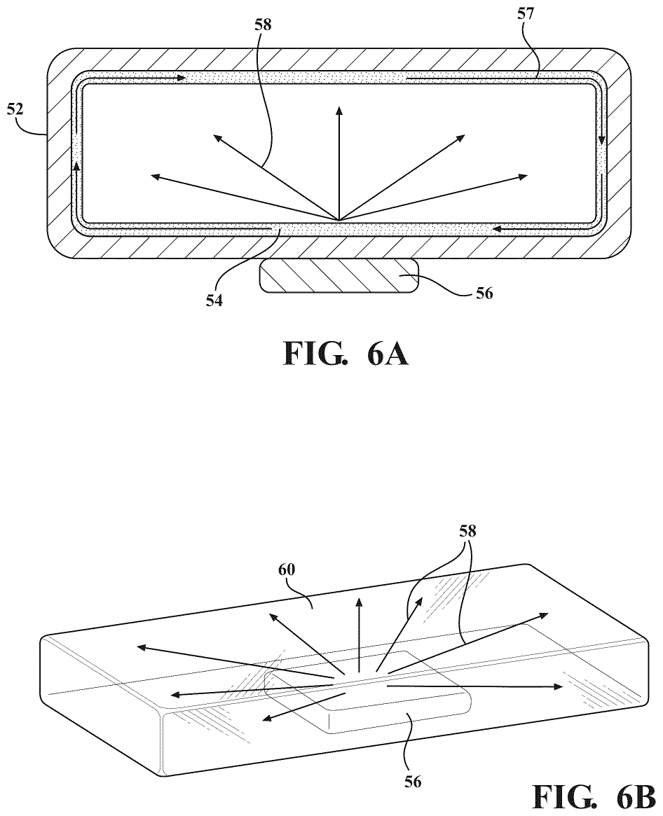

FIG. 6A provides a cutaway illustration along line 6A-6A of FIG. 4A and depicting the operation of a vapor chamber including a casing 52 surrounding a wick 54. A heat source 56 is referenced and, in response, causes a liquid fluid flow 57 within the wick 54, in combination with vapor flows 58 internally within a central vapor chamber 60

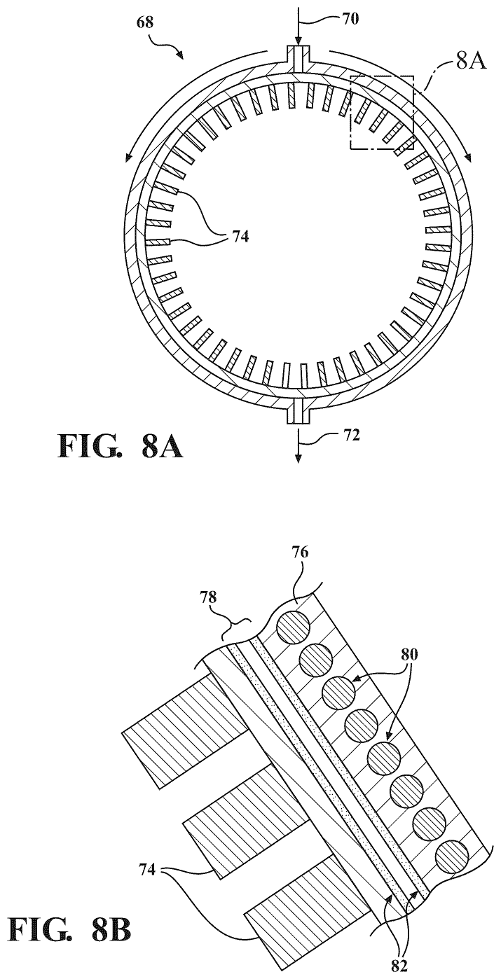

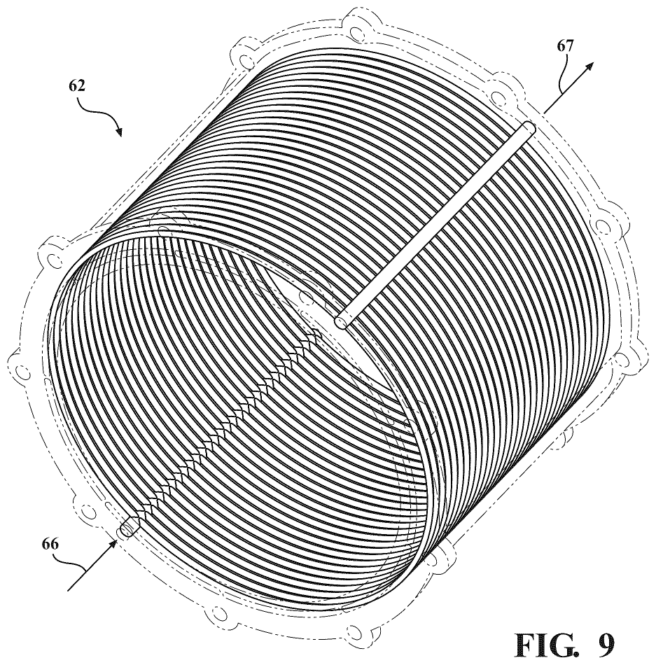

FIG. 6B presents a partially phantom perspective of the vapor chamber of FIG. 6A and illustration the spreading distribution of heat again represented at 58. As will be further described in reference to FIGS. 8A-8B, 11A-11B and 12A-12B, the vapor chamber provides for two-phase cooling via the desired spreading effect provided by the vapor chamber in combination with outer surrounding liquid coolant flow.

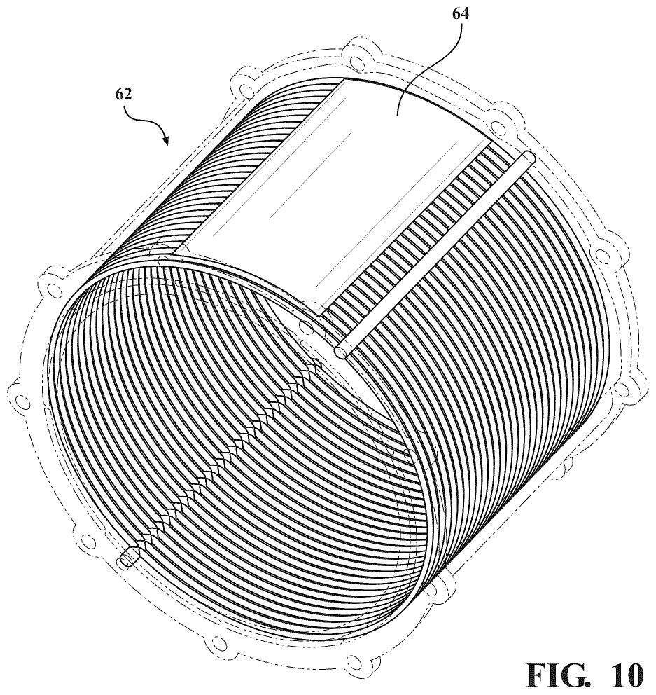

FIG. 7 provides a perspective illustration of a housing produced according to a non-limited embodiment of the present invention and depicting a cylindrical shaped housing or body 62 within which are contained a circumferential extending arrangement of vapor chambers 64 (see also FIG. 10) in combination with embedded parallel flow liquid cooling channels (further referenced by liquid cooling inlet 66). An outlet end is hidden in FIG. 7 but shown at 67 in FIG. 9.

FIG. 8A provides a cross section of an e-motor/stator housing, at 68, showing liquid coolant from an inlet manifold 70 to an outlet manifold 72. As shown, the coolant flows around the circumference of the e-motor/stator housing body with the stator windings being depicted at 74 as rectangles spaced radially about a centerline of the assembly.

FIG. 8B provides an enlarged outer wall section 76 of the e-motor/stator housing in FIG. 8A and showing the two-phase vapor chamber (heat spreader) 78 and embedded cooling channels (single-phase cooling) at 80 which are arranged in parallel and as shown extend transversely relative to the vapor chambers. Porous wicks 82 are shown lining the vapor chamber heat spreader and again operate in response to proximity to a high heat location by vaporizing the fluid within the chamber to spread heat outwardly to the parallel flow channels to facilitate cooling.

FIG. 9 presents an illustration of an e-motor/stator cylindrical shaped housing, such as again previously shown at 62 in FIG. 7, and exhibiting coolant flow between inlet 66 and outlet 67 locations with a manifold that extends the length of the housing, in combination with communicating and parallel flow coolant channels which extend about the circumference of the housing. As shown, the array of channels is disposed parallel to each other which carries coolant around the circumference of the motor/stator housing.

FIG. 10 presents an illustration of an e-motor housing according to a non-limiting embodiment and again including a plurality of nine separate vapor chambers, each spanning forty degrees of the circumference and length of the e-motor housing 62. Without limitation, the use of a given multiple of vapor chambers can be modified within the scope of the present invention.

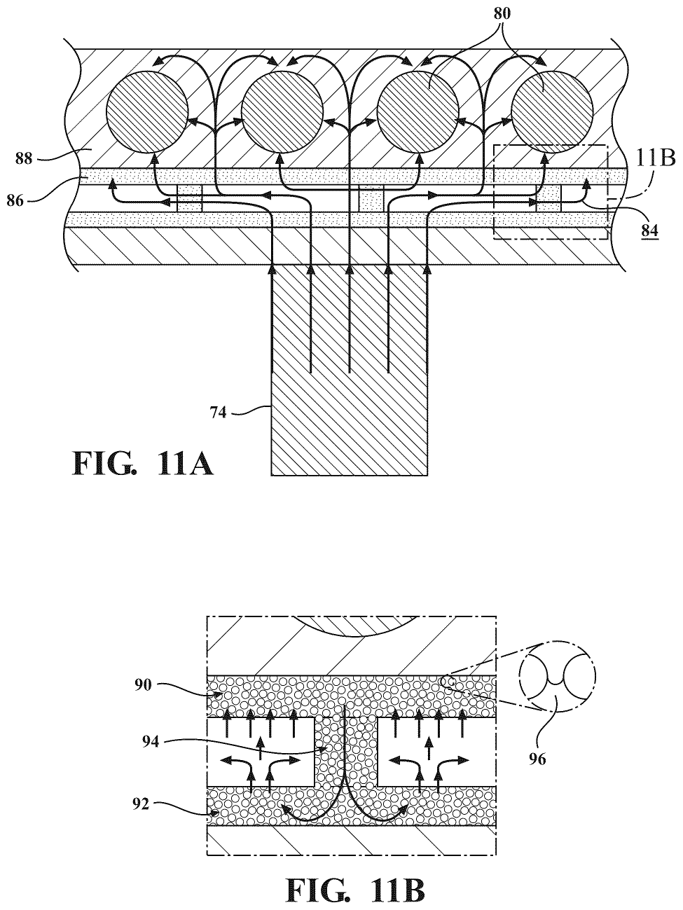

FIG. 11A presents an enlarged cross section of an e-motor/stator housing similar to FIG. 8B and depicting heat transfer from the motor winding 74 through the vapor chamber (see at 84 as compared to 78 in FIG. 8B) to the liquid coolant flowing through the coolant channels (see further again as shown at 80 in FIG. 8B). The heat generated within the windings 74 is conducted through the inner wall of the e-motor/stator housing and evaporates a liquid within the vapor chamber. The vapor 84 spreads out and carries heat away from the windings 74, following which it condenses on the outer, cooler wall of the vapor chamber 86 and releases the heat, which is subsequently conducted through the body (at 88) to the liquid cooling channels 80, whereupon the liquid cooling carries the heat out of the e-motor/stator housing via convection to such as an externally located radiator for releasing heat to ambient. The working fluid, now in the liquid phase, is then wicked back to the hot side of the vapor chamber to repeat the cycle.

FIG. 11B presents an enlargement of area 11B depicted in FIG. 11A and better showing the two phase evaporation and condensation cycle within a two-phase vapor chamber shown in FIG. 11A, facilitated by condenser 90 and evaporator 92 wicks, these interconnected by column 94 which provides a connection from the condenser (cooler walls) with the evaporator (hot) wall of the chamber. A number of these connections are formed in order to provide additional structural support in addition to the wicking function, and whereby the porous walls of the vapor chamber facilitate wicking via capillary action. This is further shown by additional enlargement at 96 whereby capillary meniscus generates driving pressure in order to facilitate the pumping capability of the capillary wicks and thereby the effectiveness of the vapor chamber/heat spreader.

Key characteristics of the design include without limitation permeability, pore radius, working fluid properties and inter-connectedness of the pores to contribute to the capillary pumping capability of the wick (and thereby the effectiveness of the vapor chamber/heat spreader).

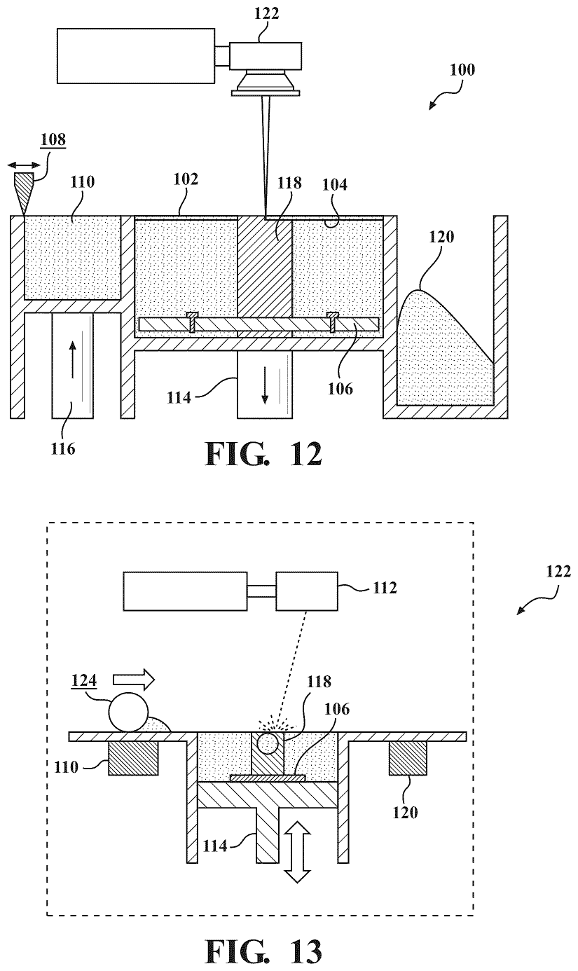

Proceeding to FIG. 12, provided is a representative illustration, generally at 100, of a laser powder bed fusion (LPBF) process for 3D or additive forming an aluminum electric motor housing, such as previously depicted at 12, and which integrates any of vapor chambers or liquid cooling paths. In a first step, a 3D CAD file is created and loaded into a forming machine (not shown).

The LPBF process begins with a metal powder is provided 102 (which can include an aluminum or like material exhibiting the desired properties of heat conductivity, weight, etc.) which is spread according to a desired layer thickness 104 across a build platform 106. A recoater blade 108 is provided for repetitively applying the layer of powder 102 from a powder feed reservoir 110 (which can be pre-heated to a consistent temperature) across the build platform 106.

A high-powered laser 112 then scans the powder, following a predetermined pattern based on the digital 3D model. The laser's heat melts the powder particles, fusing them together to form a solid layer. Once a layer is complete, the build platform descends (see descending motion of fabrication piston 114, which corresponding opposing upwardly elevating piston 116 for maintaining the feed reservoir 110 at a level to allow the recoater blade 108 to apply successive layers. This cycle repeats until the part (at 118) is fully built. After the process, the excess powder is removed (see at collection bin 120 and loose, unfused powder surrounding the printed piece 118), whereinafter the part may require post-processing, such as support removal or surface finishing.

FIG. 13 provides a related illustration, generally at 122, as compared to FIG. 12 and depicting a roller configuration (at 124) which substitutes for the recoater blade 108 of FIG. 12 for recoating the aluminum powder between each laser fusion cycle. For purposes of ease of illustration, similar numbers are provided to identify corresponding elements.

As described, the motor housing can integrate vapor chambers as part of the 3D process for providing for the transfer of heat from a location of high heat to an area of lower heat for the purpose of heat dissipation. The vapor chambers are again charged with a working fluid which passively cycles within the heat pipe via an evaporation (vapor)-condensation (liquid) cycle to move heat away from the heat source.

The working fluid, such as but not limited to acetone, is chosen for its heat-carrying capacity as well as compatibility with aluminum to avoid degradation, corrosion or chemical reaction. The number and size of heat pipes can be determined to match the expected heat transfer need taking into consideration typical motor loads, peak motor loads, optional supplemental methods of removing heat, and an engineering safety factor.

In the simplest form, the vapor chambers transfer heat to the condensation end of each vapor chamber and is dissipated to ambient air without the need for any additional directed air flow or any coolant flow. Optionally, air convection can be directed to the heat pipe evaporator end to increase the rate of heat transfer. This can be achieved by scoops, ducts or conduits which redirect the air flow around and/or under a vehicle as it moves so that a certain amount is redirected toward the motor. Alternatively, a fan can be incorporated to direct air toward the condenser end of each vapor chamber. In either the air-redirection or the fan-forced-convection case, cooling fins can be incorporated at the condenser end of the vapor chambers to provide additional surface area facilitating heat transfer from away from the motor and housing.

In another embodiment, liquid cooling can be incorporated to supplement the passive vapor chamber system. Coolant flowing in close contact with the motor will transfer heat for dissipation away from the motor, typically via a radiator.

As previously described, any arrangement of cooling paths can be formed and again not being limited parallel, spiraling or bio-mimicking in shape and which can be engineered via optimization algorithms, by which fluid flow is directed to the areas of highest heat within the motor. Furthermore, bio-mimicking cooling channels, by their organic form mimick what is found in plants and nature, and improves the energy efficiency of a thermal system by reducing the fluid flow pressure drop as it is pumped through the system.

The corresponding additive process for forming the motor housing includes the steps of creating a CAD program corresponding to a series of build cycles for forming the housing and loading into a controller of a forming machine, initiating a first build cycle by spreading a layer of a metal powder drawn from a feed reservoir by an applicator according to a desired thickness across a build platform, and melting and fusing together a portion of the powder to form a solid layer. Additional steps include vertically displacing the build platform a distance and initiating a succeeding build cycle by repetitively spreading a succeeding layer of the metal powder and fusing a subsequent portion to form a succeeding solid layer, following which a set number of additional build cycles are performed until a completed housing is produced which integrates an arrangement of heat pipes or vapor chambers. A remaining non-fused portion of the metal powder is removed and deposited into a collection reservoir.

The step of spreading a layer of a metal powder drawn from a feed reservoir by an applicator further includes providing the applicator as a recoater blade or, alternatively, a roller. Yet additional steps include incorporating bio-mimicking cooling paths or liquid cooling channels into the build cycles forming the completed housing. The step of the forming the cooling paths can include them being engineered via optimization algorithms incorporated into the CAD program.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. An electric motor housing, comprising:
a body constructed from an aluminum alloy and integrating vapor chambers charged with a working fluid which operates in an evaporation-condensation cycle for providing for the transfer of heat from a location of high heat to an area of lower heat for the purpose of heat dissipation.

2. The electric motor housing of claim 1, further comprising said body having a cylindrical shape with an outer wall integrating said vapor chambers in circumferential extending fashion.

3. The electric motor housing of claim 2, each of said vapor chambers further comprising porous walls acting as a wick located on each of a hotter evaporating side and a cooler condensing side for transferring heat outwardly.

4. The electric motor housing of claim 2, further comprising liquid cooling channels incorporated into said outer wall outwardly from said vapor chambers and arranged in parallel and extending transversely relative to the vapor chambers between inlet and outlet ends for convecting heat from said vapor chambers to a location external from said body.

5. The electric motor housing of claim 3, said liquid cooling channels further comprising organic bio-mimicking paths.

6. The electric motor housing of claim 4, further comprising said liquid cooling channels being engineered via optimization algorithms, such that fluid flow is directed to the areas of highest heat within said body.

7. The electric motor housing of claim 5, further comprising said bio-mimicking paths improving the energy efficiency of a thermal system by reducing a fluid flow pressure drop as it is pumped through the system.

8. The electric motor housing of claim 4, said vapor chambers being charged with a working fluid which passively cycles in an evaporation (vapor)-condensation (liquid) cycle to move heat away from the high heat location.

9. An electric motor housing comprising:
an outer body constructed from an aluminum alloy and integrating heat pipes which operates in an evaporation-condensation cycle for providing for the transfer of heat from a location of high heat to an area of lower heat for the purpose of heat dissipation; and
said heat pipes being supplemented with organic bio-mimicking cooling channels which are engineered to direct flow to the areas of highest heat and are optimized to reduce pumping pressure drop.

10. The electric motor housing of claim 9, said additive printing process further comprising laser powder bed fusion for fabricating said outer body.

11. An additive process for forming a motor housing, comprising the steps of:
creating a CAD program corresponding to a series of build cycles for forming the housing and loading into a controller of a forming machine;
initiating a first build cycle by spreading a layer of a metal powder drawn from a feed reservoir by an applicator according to a desired thickness across a build platform;
melting and fusing together a portion of the powder to form a solid layer;
vertically displacing the build platform a distance and initiating a succeeding build cycle by repetitively spreading a succeeding layer of the metal powder and fusing a subsequent portion to form a succeeding solid layer;
performing a set number of additional build cycles until a completed housing is produced integrating any of heat pipes or vapor chambers; and
removing a remaining non-fused portion of the metal powder into a collection reservoir.

12. The process according to claim 11, said step of spreading a layer of a metal powder drawn from a feed reservoir by an applicator further comprising providing the applicator as a recoater blade.

13. The process according to claim 11, said step of spreading a layer of a metal powder drawn from a feed reservoir by an applicator further comprising providing the applicator as a roller.

14. The process according to claim 11, further comprising the step of incorporating bio-mimicking cooling paths or liquid cooling channels into the build cycles forming the completed housing.

15. The process according to claim 11, further comprising the step of the cooling paths engineered via optimization algorithms incorporated into the CAD program.
